(19) United States
(12) Patent Application Publication
(10) Pub. No.: US 2018/0345565 A1
(43) Pub. Date: Dec. 6, 2018

(54) METHOD FOR PRODUCING A FLEXIBLE POUCH MADE OF FLEXIBLE THERMOPLASTIC MATERIAL

(71) Applicants: NEXTIS, Chalon Sur Saone (FR); MATISSART NORD, Labourse (FR)

(72) Inventors: Catherine BLANC NÉE PETIOT, Saint Marcel (FR); Yannick CELERIER, Aluze (FR); Pascal ODE, Neuilly Sur Seine (FR); Julien PAPILLON, Garches (FR)

(73) Assignees: NEXTIS, Chalon Sur Saone (FR); MATISSART NORD, Labourse (FR)

(21) Appl. No.: 15/777,307

(22) PCT Filed: Nov. 18, 2016
(86) PCT No.: PCT/FR2016/053021

§ 371 Date: May 18, 2018

(30) Foreign Application Priority Data
Nov. 18, 2015 (FR) 1561096

(51) Int. Cl. B29C 49/20; B29C 49/04; B29C 49/00; B29C 49/42; B65B 3/02

(52) U.S. Cl. CPC B29C 49/20; B29C 49/04; B29C 49/0005; B29K 2075/00; B65B 3/022; B29C 2049/2008; B29C 49/4273

(57) ABSTRACT

A method for producing a flexible pouch made of flexible thermoplastic material, including steps of: (i) preparing hot flexible thermoplastic material in a pasty state, (ii) placing a so-called “proximal” pre-molded insert onto a mounting such that the insert is arranged in a ring around the mounting, (iii) coating all or part of the insert with hot flexible thermoplastic material in the pasty state, (iv) locking the blow-mold shells around the insert, and (v) injecting a pressurized gas into the chamber so as to expand the sleeve from inside onto the inner surface of the mold or expand the sleeve from the outside by creating negative pressure inside the chamber.

### TECHNICAL FIELD

The present invention relates to a method for producing a flexible pouch for medical use made of flexible thermoplastic material. The present invention also relates to flexible pouches obtained by said method.

### PRIOR ART

Flexible pouches intended to contain liquids are well-known to the prior art and are used particularly to transport and store liquids intended for nutrition or for medical use.

Of the pouches intended to transport liquid food, mention may particularly be made of the pouches intended to transport beverages in the context of sports activities (also referred to as “camel bags”). However, this use remains limited compared to rigid plastic containers (e.g. polyethylene) representing a majority in the field.

The use of flexible pouches is much more developed in the medical field where flexibility is particularly important as it makes it possible to obtain zero-volume chambers (i.e. empty of gas and particularly of ambient air) in the absence of internal liquid. As such, flexible pouches make it possible to retain the asepsis of the products contained (blood, solutions, medicinal products) throughout the use thereof.

At the present time, all flexible pouches, of the medical or nutritional pouch type, are produced with high-frequency or heat-sealing, using thermoplastic films. More specifically, the pouches are produced by sealing two layers on top of one another, sparing the content area. In general, the films are made of PVC (Polyvinyl chloride) or PP (Polypropylene) and the pouches may have different sizes to exhibit a content volume between 50 and 1000 ml.

Current pouches fulfil the main function thereof, but all have drawbacks due to both the materials, as well as the manufacturing method.

The first drawback is associated with the obligatory use of plasticiser in the thermoplastic materials used (particularly in the case of PVC). These different plasticisers may tend to migrate into the liquid which raises major health problems, particularly in the case of liquids that are injectable or ingested by humans.

Moreover, the use of films gives rise to a certain number of obligatory steps among which mention may particularly be made of rolling, cutting, flat sealing and final assembly of the pouch obtained with the insert acting as plugging means.

Besides being time-consuming, these different steps give rise to product losses associated with cutting and the production of bothersome structures such as potentially sharp edges.

Therefore, the present invention proposes to offer a method for producing flexible pouches intended to contain liquids circumventing the problems raised above. More particularly, said method is more economical and makes it possible to obtain flexible pouches with no edges and not necessarily requiring additives such as plasticisers.

### SUMMARY OF THE INVENTION

As such, the present invention relates to a method for producing a flexible pouch made of flexible thermoplastic material characterised in that it comprises steps consisting of:

(i) preparing said hot flexible thermoplastic material in a pasty state,

(ii) placing a pre-moulded insert, or proximal insert, onto a mounting such that said insert is arranged in a ring around said mounting,

(iii) coating all or part of said insert with hot flexible thermoplastic material in a pasty state,

(iv) locking the blow-mould shells around said insert,

(v) injecting a pressurised gas into said chamber so as to expand the sleeve from the inside onto the inner surface of said mould.

Alternatively, step (v) may be replaced by a step (V′) consisting of expanding the sleeve from the outside by creating negative pressure inside said chamber.

Step (v) of the method according to the invention may be carried out via an injection needle or a blow pin.

Advantageously, said mounting is a blow pin comprising a blow moulding area and said insert is arranged in a ring around said pin such that the blow moulding area of said pin is downstream from or inside said insert, the subsequent steps of the method consisting of

(iii) coating all or part of said insert and said blow pin with hot flexible thermoplastic material in a pasty state,

(iv) locking the blow-mould shells around said blow pin and said insert,

(v) injecting a pressurised gas into said chamber via said blow moulding area so as to expand the sleeve from the inside onto the inner surface of said mould.

Flexible thermoplastic materials are well-known to those skilled in the art. Preferentially, said flexible thermoplastic material is chosen from the group comprising polyurethane, thermoplastic elastomers (TPE, TPE-A, PEBA, PP EPDM, SEBS, EVA, etc.) and flexible PVCs. According to one very much preferred embodiment, the latter material has the advantage of being suitable for use without additives.

Blow pins are also well-known to those skilled in the art, they are generally cylindrical in shape, hollow and comprise at the end thereof or on the surface thereof one or a plurality of holes communicating with the inside of the pin. The blow pins are usually connected to a gas source which will circulate inside the pin and towards the outside via said holes.

Within the scope of the present invention, the term “blow moulding area” refers to the region of the blow pin comprising the hole(s) via which the gas is injected.

Within the scope of the present invention, the term “distal” refers to the portion of the blow pin closest to the free end thereof and furthest from the connection to the gas source. The term “proximal” is defined by opposition with the term “distal”.

Within the scope of the present invention, the term “downstream” denotes the portion of the pin in the direction of the distal part, in contrast, the term “upstream” denotes the portion of the pin in the direction of the proximal part.

Within the scope of the present invention, the term “coat” signifies that said flexible thermoplastic material forms a chamber around said blow pin and said insert so as to surround at least a part of the injection area. As such, the injection of gas via the hole(s) of the blow pin will induce the expansion of said flexible thermoplastic material against the walls of said mould.

The insert may be entirely coated with the flexible thermoplastic material or be coated merely on the distal portion thereof, thereby leaving the proximal portion thereof bare.

The coating of the blow pin may be embodied in the form of a parison or a sleeve extruded as the production method according to the invention progresses.

Said parison may be of constant or variable thickness from one area to another of said parison.

According to one preferred embodiment of the invention, said method uses at least one second insert, or distal insert, arranged in a ring at the distal end of said blow pin such that said inserts surround said blow moulding area. Advantageously, said second insert is also coated wholly or partly with said flexible thermoplastic material during step (iii).

Alternatively, the second insert may be arranged on another mounting, different to the blow pin.

As such, it is possible to obtain flexible pouches comprising two inserts arranged on either side of the internal volume.

According to one preferred embodiment of the invention, said sleeve or said parison of hot flexible thermoplastic material in a pasty state coats said blow pin and said insert under the effect of gravity.

According to one even more preferred embodiment of the invention, said blow pin and said insert are introduced via the bottom of said mould, the distal portion of said pin being at a greater height than the proximal part of said pin.

According to one very much preferred embodiment, said blow pin and said insert are introduced via the bottom of said mould, the distal portion of said pin being at a greater height than the proximal part of said pin and said parison is introduced via the top of said mould.

According to one preferred embodiment of the invention, said blow pin is mounted in rotation about the longitudinal axis thereof. In this embodiment, it is possible to use inserts with internal threading which will be suitable for being linked with and/or separated from said blow pin by a rotational movement of said blow pin.

According to one preferred embodiment of the invention, said blow pin comprises a plurality of branches each bearing a proximal insert.

This embodiment makes it possible to obtain flexible pouches comprising a plurality of inserts arranged at the same end of said flexible pouch. This embodiment also makes it possible to obtain flexible pouches comprising a plurality of inserts at one end of the flexible pouch and one or a plurality of inserts at the other end of said pouch.

Within the scope of this embodiment, said blow pin will take the form of a fork comprising a plurality of extensions referred to as “branches” and each comprising a free end.

According to an even more preferred embodiment of the invention, at least one of the branches further bears a distal insert.

According to an even more preferred further embodiment, said branches are mounted movable in translation with respect to one another so as to be able to move away from one another. This particular embodiment makes it possible to stretch said parison laterally.

As such, the present invention relates to a method comprising a step consisting of separating the branches of said blow pin after step (iii) of the method according to the invention.

According to one preferred embodiment of the invention, said method comprises a filling step, after step (v) or (v′) but prior to releasing the mould, where said flexible pouch is filled with a liquid or a gel.

The present invention also relates to a flexible pouch made of flexible thermoplastic material obtained by any of the methods according to the invention.

### BRIEF DESCRIPTION OF THE FIGURES

FIGS. 1a-1b show an embodiment of a flexible pouch according to the invention comprising a proximal insert.

FIGS. 2a-2c show a second embodiment of a flexible pouch according to the invention comprising a proximal insert and a distal insert. FIGS. 2a-2c also show the position of the inserts on the blow pin during the execution of the method according to the invention.

FIGS. 3a-3d show an embodiment of a flexible pouch according to the invention comprising a plurality of proximal inserts.

### DESCRIPTION OF THE EMBODIMENTS OF THE INVENTION

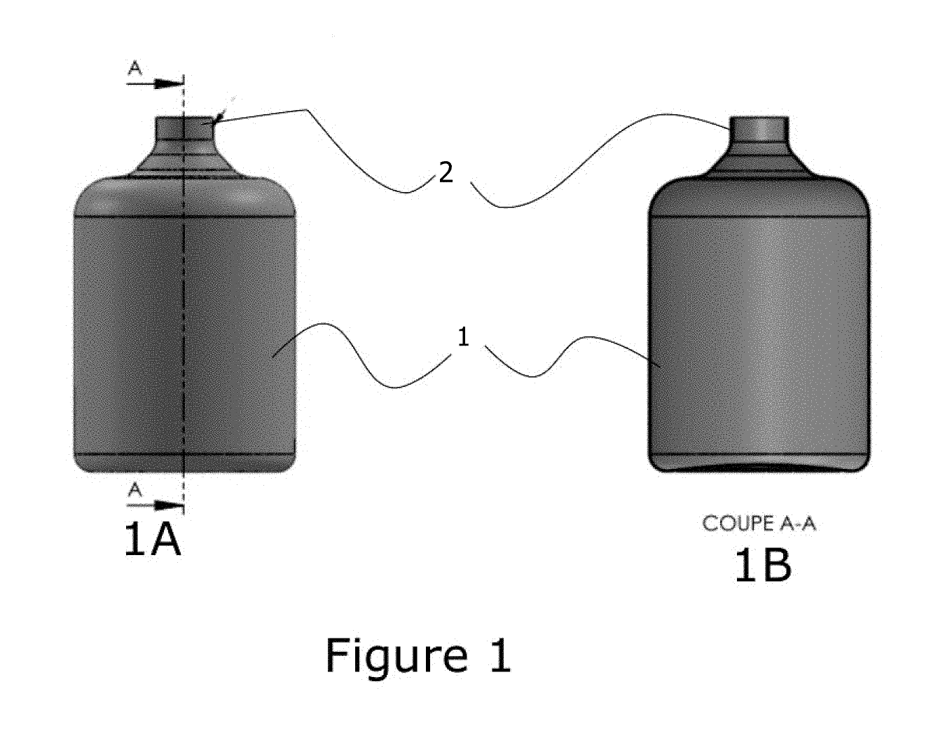

FIG. 1a shows a side view of a flexible pouch 1 according to the invention and FIG. 1b shows a longitudinal sectional view along the plane A-A of the same pouch. The flexible pouch 1 comprises an insert 2 suitable particularly for use as an access point inside the pouch 1.

The insert 2 may take any of the forms routinely used in this type of product provided that it includes a longitudinal hole for the passage of the blow pin during the method according to the invention. The blow pin 4 is dimensioned so as extend longitudinally from the upstream of the insert to the free end thereof via said insert. Once the blow pin 4 has been placed in the mould, the free end thereof is ideally placed inside the mould at the end of the wall forming the bottom of the flexible pouch 1.

The insert 2 may advantageously comprise on the bare proximal portion thereof a threading suitable for engaging with a plug.

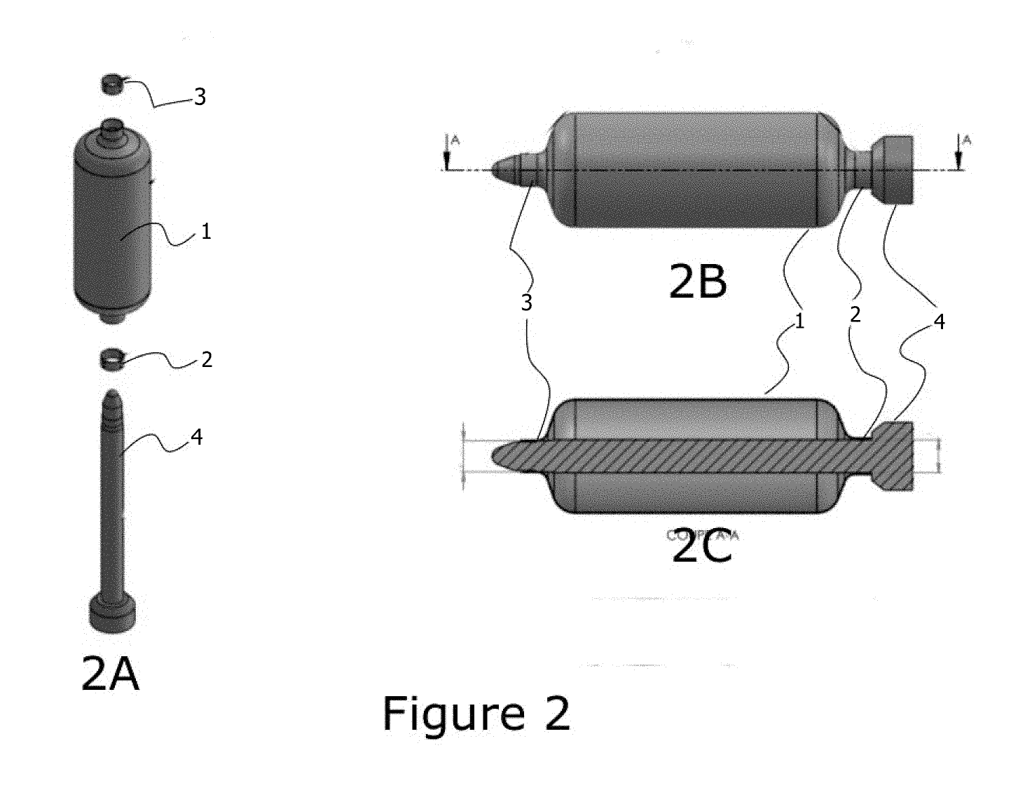

FIG. 2a shows a perspective view of a second embodiment of a flexible pouch 1 according to the invention comprising a proximal insert 2 and a distal insert 3. FIG. 2a also shows a perspective view of the blow pin 4. FIG. 2b shows a side view of said pouch 2 with the pin 4 in position and FIG. 2c a longitudinal sectional view along the plane A-A.

The proximal insert 2 and the distal insert 3 are placed in a ring around the blow pin 4 which will at the same time enable the positioning of these inserts with respect to the rest of the pouch 1 and also serve to inject gas into the area between the two inserts 2, 3 and enable blow moulding of the flexible thermoplastic material forming the pouch.

Once in place, the two inserts 2, 3 and the blow pin 4 will be coated with hot flexible thermoplastic material in a pasty state according to the extrusion blow moulding method. Advantageously, the blow pin is arranged such that the distal part thereof is plumb with the proximal part thereof and so as to be introduced into the mould opposite said parison. More specifically, the hot flexible thermoplastic material is extruded via a set of punches and dies preferentially placed plumb with and on either side of the blow pin. This sleeve may have a cross-section of variable shape according to the nature of the pouch to be moulded. Usually, said cross-section may be circular or oval. The hot flexible thermoplastic material sleeve will thereby be suitable for descending by gravity on either side of the blow pin. The ideal flexible thermoplastic material extrusion conditions are well-known to those skilled in the art. Preferentially, the extrusion dies are preferentially set to obtain sleeves of thickness between 0.1 and 10 mm.

Moreover, the flexible thermoplastic material sleeve is also surrounded by the shells of the mould used to form the pouch.

The mould used is a conventional extrusion blow moulding mould comprising preferentially two shells comprising cavities intended to form the pouch and the portion thereof to be over-moulded on the surface of the inserts. The mould is preferentially associated with heating means suitable for keeping the shells at a suitable temperature for flexible thermoplastic material blow moulding.

Once the blow pin 4 and the inserts 2, 3 are surrounded by the flexible thermoplastic material sleeves, the shells of the mould will form a tight chamber around same. The gas is then injected, via the blow pin 4 which will cause the expansion of the flexible thermoplastic material against the walls of the mould.

This step may be combined with an “in-mould labelling” method thereby enabling the marking of the pouch simultaneously with the blow moulding thereof.

The pressure and the quantity of gas injected are adapted to the size and shape of the pouch 1 sought.

The method according to the invention may also be used to obtain a flexible pouch further comprising one or more inserts to be positioned outside the flexible pouch. In this embodiment, the parison of flexible thermoplastic material will be preferentially over-moulded against the face to be in contact with the insert.

After formation of the pouch 1, the shells of the mould may be separated and the pouch 1 separated from the blow pin 4.

The steps described above may be automated and repeated as required.

It is as such understood that the use of an extrusion-blow moulding/over-moulding method for the production of flexible pouches made of flexible thermoplastic material makes it possible to obtain in a single step a pouch 1 not comprising edges with no material loss.

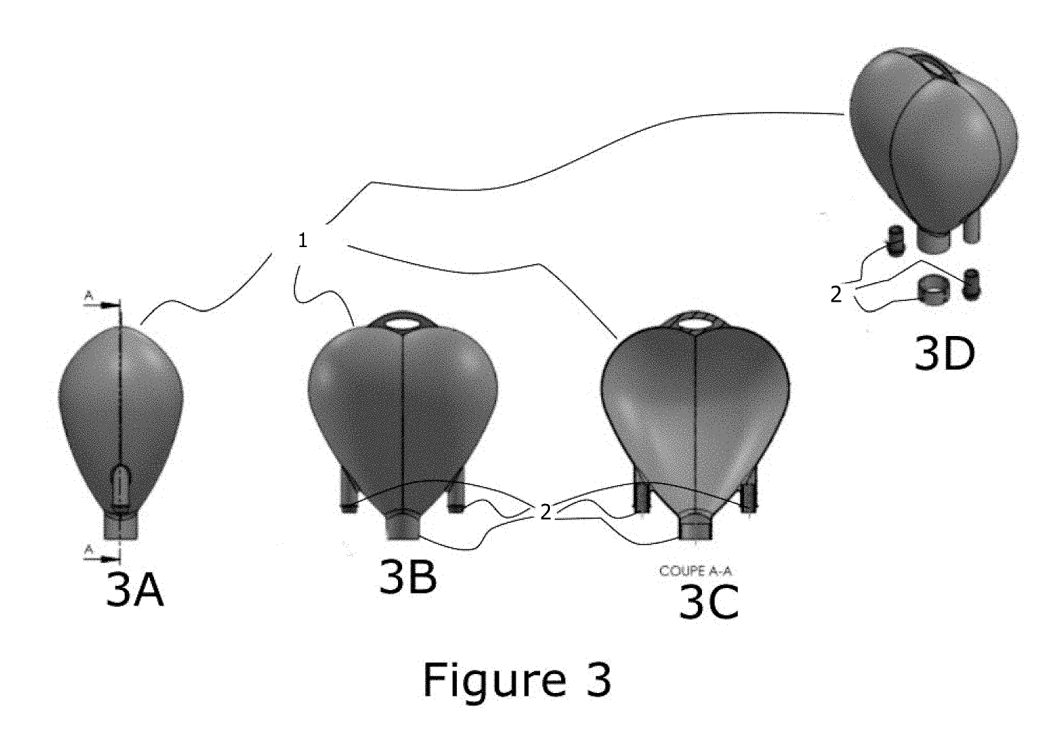

FIG. 3a shows a profile view of a further embodiment of a flexible pouch 1 according to the invention comprising a plurality of proximal inserts 2. FIG. 3b shows a front view of the same embodiment, FIG. 3c show a sectional view along the plane 1-1 and FIG. 3d shows an exploded view of said pouch 1.

The latter type of pouch 1 is obtained using a blow pin 4 comprising a plurality of branches (e.g. assembled in a trident shape), of which at least one comprises an injection area, and suitable for receiving a proximal insert.

The method according to the invention makes it possible to manufacture pouches for various sectors of activity (medical, pharmaceutical, hygiene, cosmetics, food, etc.) of 3D geometry with particularly the possibility of obtaining fun shapes for children (animals, cartoon characters, flowers, smiley faces, fruit, various objects, etc.).

1-8. (canceled)

9. A method for producing a flexible pouch made of flexible thermoplastic material comprising:
(i) preparing said hot flexible thermoplastic material in a pasty state,
(ii) placing a pre-moulded insert, or proximal insert, onto a blow pin, mounted in rotation about the longitudinal axis thereof and comprising a blow moulding area, said insert being arranged in a ring around said pin such that the blow moulding area of said pin is downstream from or inside said insert,
(iii) coating all or part of said insert with hot flexible thermoplastic material in a pasty state in the form of a parison or a sleeve,
(iv) locking the blow-mould shells around said insert so as to form a chamber, said blow pin and said insert being introduced via the bottom of said mould, the distal portion of said pin being at a greater height than the proximal part of said pin and said parison being introduced via the top of said mould,
(v) injecting a pressurised gas into said chamber so as to expand the sleeve from the inside onto the inner surface of said mould or expand the sleeve from the outside by creating negative pressure inside said chamber.

10. The method for producing a flexible pouch made of flexible thermoplastic material according to claim 9 wherein the flexible thermoplastic material is a polyurethane.

11. The method for producing a flexible pouch made of flexible thermoplastic material according to claim 9 wherein it uses a second insert, or distal insert, arranged in a ring at the distal end of said blow pin such that said inserts surround said gas injection area.

12. The method for producing a flexible pouch made of flexible thermoplastic material according to claim 9 wherein said sleeve or said parison of hot flexible thermoplastic material in a pasty state coats said blow pin and said insert under the effect of gravity.

13. The method for producing a flexible pouch made of flexible thermoplastic material according to claim 9 wherein said blow pin comprises a plurality of branches each bearing a proximal insert.

14. The method for producing a flexible pouch made of flexible thermoplastic material according to claim 9 wherein at least one of the branches further bears a distal insert.

15. The method for producing a flexible pouch made of flexible thermoplastic material according to claim 13 wherein said branches are mounted movable in translation with respect to one another so as to be able to move away from one another.

16. The method for producing a flexible pouch made of flexible thermoplastic material according to claim 9 wherein said method comprises a filling step, after step (v) or (v′) but prior to releasing the mould, where said flexible pouch is filled with a liquid or a gel.
